(19) United States
(12) Patent Application Publication
(10) Pub. No.: US 2022/0030419 A1
(43) Pub. Date: Jan. 27, 2022

(54) METHOD FOR SECURE GUEST MODE DEVICE-TO-DEVICE COMMUNICATIONS

(71) Applicant: QUALCOMM Incorporated, San Diego, CA (US)

(72) Inventors: Dinesh Singh LOUREMBAM, Hyderabad (IN); Ankush AGARWALLA, Angul (IN); Siva Ramesh Kumar ANDEY, Hyderabad (IN); Naga Mohana Krishna VADUGURI, Hyderabad (IN)

(21) Appl. No.: 16/934,579

(22) Filed: Jul. 21, 2020

(51) Int. Cl. H04W 12/00; H04W 12/06; H04W 12/08; H04L 29/06; H04W 4/80

(52) U.S. Cl. CPC H04W 12/003; H04W 12/06; H04W 4/80; H04L 63/083; H04W 12/08

(57) ABSTRACT

Various embodiments include methods for establishing secure device-to-device communications. Embodiments may include receiving a connection type selection by a user for connecting the first wireless device to the second wireless device, and connecting to the second wireless device using a one-time password (OTP) exchange and selected features access permissions. Embodiments may further include storing a device identification (ID) of the second wireless device for a duration of the wireless connection, and deleting the stored device ID upon disconnection of the first wireless device from the second wireless device to prevent future automatic connections.

### BACKGROUND

Bluetooth (BT) and Bluetooth Low Energy (BLE) capable electronic devices may establish device-to-device connections, or pairings, with external devices located with proximity. Wireless device implementing BT/BLE communications may perform handshaking protocols to establish a wireless device-to-device communications links. However, once connected, BT/BLE paired devices store device identification (ID) and other information for ease of automatically establishing subsequent connections without further authentication. For example, two paired BLE-enabled devices may establish a connection, request and store the corresponding device ID(s), and terminate the connection by moving out of effective communication range. If the two devices enter the effective communications range again, the devices will detect each other, determine that the device ID was used in a previously successful device-to-device connection, and automatically connect the devices without additional authentication. As such, no additional authentication may be required to automatically pair wireless devices, with or without knowledge of the user(s), unless the device ID are manually forgotten (e.g., the user unpairs or forgets a device within configuration settings).

Bluesnarfing is digital information theft that is carried out by an attacker who obtains unauthorized access to a victim's device, usually through bluebugging. In bluebugging, attackers take control of BLE devices without the user's knowledge. Bluebuggers may target devices that are in discoverable mode. “Bluebuggers” and “Bluesnarfers” may take advantage of the automatic BLE connection capabilities, allowing attackers to steal valuable digital user information including one-time passwords (OTP), contact and message information, photographs, application data, and the like, without consent or knowledge of a user.

### SUMMARY

Various aspects include methods performed by a processor of a first wireless device to establish secure communications with a second wireless device.

Various aspects may include receiving a connection type selection by a user for connecting the first wireless device to the second wireless device, establishing a wireless connection to the second wireless device using a one-time password (OTP) exchange and selected features access permissions, and in response to determining that a user selected connection type is a one-time temporary access connection type, storing a device identification (ID) of the second wireless device for a duration of the wireless connection and deleting the stored device ID upon disconnection of the first wireless device from the second wireless device to prevent future automatic connections.

Some aspects may further include, in response to determining that the user selected connection type is a limited feature access connection type, displaying, in a user interface, a list of selected features accessible in subsequent connections which are already configured by the user in the limited features configuration settings module and storing, in a limited features database, the device ID of the second wireless device in association with the selected features.

Some aspects may further include disconnecting the first wireless device from the second wireless device, overriding access permissions granted to the second wireless device in configuration settings of the first wireless device based on the limited features configuration settings module, receiving a subsequent device ID from a subsequent wireless device, comparing the subsequent device ID against the device ID stored in the limited features database, determining whether the subsequent device ID matches the device ID such that the subsequent wireless device is the second wireless device, and automatically connecting to the second wireless device based on the overridden access permissions in response to determining that the subsequent device ID matches the device ID.

Some aspects may further include displaying, in the user interface, a permanent upgrade option and a temporary upgrade option for permanently or temporarily upgrading to the selected features stored in the limited features database associated with the device ID, receiving a selection of an upgrade option to upgrade to the selected features permanently or temporarily, and determining whether the selected upgrade option is the permanent upgrade option or the temporary upgrade option. Some aspects may further include, in response to determining that the selected upgrade option is a temporary upgrade option, upgrading access permissions to allow the second wireless device to access the selected features of the first wireless device, disconnecting the first wireless device from the second wireless device, overriding access permissions granted to the second wireless device in the configuration settings of the first wireless device based on the limited features configuration settings module. Some aspects may further include, in response to determining that the selected upgrade option is a permanent upgrade option, storing the device ID in a user database and deleting the device ID from the limited features database.

Some aspects may further include in response to determining that the user selected connection type is a future alert access connection type, storing, in an alert database, the device ID of the second wireless device, disconnecting the first wireless device from the second wireless device, receiving a subsequent device ID from a subsequent wireless device, comparing the subsequent device ID against the device ID stored in the alert database, determining whether the subsequent device ID matches the device ID such that the subsequent wireless device is the second wireless device, and transmitting a notification to the second wireless device that includes a request for additional authentication information in response to determining that whether the subsequent device ID matches the device ID.

In some aspects, receiving a user connection selection for connecting the first wireless device to the second wireless device may further include receiving, from a user interface of the first wireless device, a selection of the second wireless device from a list of available wireless devices to begin establishing a wireless connection with the second wireless device, displaying, on the user interface, a user-selectable option to establish the wireless connection using a guest mode, receiving, from the user interface, a selection to establish the wireless connection using the guest mode, and displaying, on the user interface, user-selectable options for guest mode connection types.

In some aspects, connecting the first wireless device to the second wireless device may be performed according to Bluetooth Low Energy (BLE) communication standards.

In some aspects, connecting the first wireless device to the second wireless device may be performed according to Wi-Fi communication standards.

Further aspects include a wireless device having a processor configured to perform operations of any of the methods summarized above. Further aspects include a non-transitory processor-readable storage medium having stored thereon processor-executable instructions configured to cause a processor of a wireless device to perform operations of any of the methods summarized above. Further aspects include a wireless device having means for performing functions of any of the methods summarized above. Further aspects include a system on chip for use in a wireless device that includes a processor configured to perform operations of any of the methods summarized above. Further aspects include a system in a package that includes two systems on chip for use in a wireless device that includes a processor configured to perform operations of any of the methods summarized above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the various embodiments.

FIG. 1 is a system block diagram illustrating an example device-to-device communications system 100 according to some embodiments.

FIG. 2 is a component block diagram illustrating an example computing system 200 that may be configured to establish secure device-to-device communications between two wireless devices according to some embodiments.

FIG. 3 is a component block diagram illustrating an example system 300 configured to establish secure device-to-device communications between two wireless devices according to some embodiments.

FIGS. 4A-4F illustrate a process flow diagram of a method 400 for establishing secure device-to-device communications between two wireless devices according to some embodiments.

FIGS. 5A-5E illustrate an example mobile device 500 (e.g., user wireless device) for displaying and receiving selections for establishing secure communications with another wireless device according to some embodiments.

FIG. 6 is a process flow diagram illustrating a method 600 for establishing secure device-to-device communications between two wireless devices according to some embodiments.

FIG. 7 is a process flow diagram illustrating alternative operations that may be performed by a processor of a wireless device as part of the method 600 for establishing secure device-to-device communications between two wireless devices according to some embodiments.

FIG. 8 is a process flow diagram illustrating alternative operations that may be performed by a processor of a wireless device as part of the method 600 for establishing secure device-to-device communications between two wireless devices according to some embodiments.

FIG. 9 is a process flow diagram illustrating alternative operations that may be performed by a processor of a wireless device as part of the method 600 for establishing secure device-to-device communications between two wireless devices according to some embodiments.

FIG. 10 is a process flow diagram illustrating alternative operations that may be performed by a processor of a wireless device as part of the method 600 for establishing secure device-to-device communications between two wireless devices according to some embodiments.

FIG. 11 is a component block diagram of an example wireless device in the form of a smartphone 1100 suitable for implementing some embodiments.

### DETAILED DESCRIPTION

Various embodiments will be described in detail with reference to the accompanying drawings. Wherever possible, the same reference numbers will be used throughout the drawings to refer to the same or like parts. References made to particular examples and embodiments are for illustrative purposes and are not intended to limit the scope of the various embodiments or the claims.

Various embodiments include methods that enable wireless devices to permit a guest wireless device to establish a secure communications link while limiting subsequent connection capabilities and access rights.

The term “wireless device” is used herein to refer to any one or all of cellular telephones, smartphones, portable computing devices, personal or mobile multimedia players, autonomous vehicles, unmanned aerial vehicles (UAV), wireless communication elements within autonomous and semiautonomous vehicles, wireless devices affixed to or incorporated into various mobile platforms, global positioning system devices, vehicle computing devices, infotainment systems in vehicles, autonomous vehicle control systems, laptop computers, tablet computers, smartbooks, ultrabooks, palmtop computers, wireless electronic mail receivers, multimedia Internet-enabled cellular telephones, medical devices and equipment, biometric sensors/devices, wireless router devices, wireless appliances, wearable devices including smart watches, and entertainment devices (such as wireless gaming controllers, music and video players, satellite radios, etc.), and similar electronic devices that include a memory, wireless communication components and a programmable processor.

The term “system-on-a-chip” (SOC) is used herein to refer to a single integrated circuit (IC) chip that contains multiple resources or processors integrated on a single substrate. A single SOC may contain circuitry for digital, analog, mixed-signal, and radio-frequency functions. A single SOC also may include any number of general purpose or specialized processors (digital signal processors, modem processors, video processors, etc.), memory blocks (such as ROM, RAM, Flash, etc.), and resources (such as timers, voltage regulators, oscillators, etc.). SOCs also may include software for controlling the integrated resources and processors, as well as for controlling peripheral devices.

The term “system-in-a-package” (SIP) may be used herein to refer to a single module or package that contains multiple resources, computational units, cores or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high speed communication circuitry and packaged in close proximity, such as on a single motherboard or in a single wireless device. The proximity of the SOCs facilitates high speed communications and the sharing of memory and resources.

As described above, Bluetooth (BT), and Bluetooth Low Energy (BLE) enabled devices may be susceptible to security attacks resulting from the lack of continuous authentication after an initial device-to-device connection has been made. Once connected, BT/BLE-enabled devices may automatically connect when within range of another recognized BT/BLE enabled device. For example, a wireless device may pair with another wireless device via BLE protocols, store the device identification (ID) of the other wireless device, and automatically connect to the wireless device at any future time after detecting and recognizing the wireless device via the device ID. Thus, attackers may be able to obtain digital information from other wireless devices by connecting during a first device-to-device communication instance, and then moving within range to automatically establish another connection at some time in the future without the knowledge or consent of the other user.

For example, a guest user may connect their BLE-enabled device to a host user's vehicle infotainment system with his consent. This is a legitimate connection as long as user1 is aware. The connection may be terminated when the guest user wireless device moves out of communication range of the vehicle infotainment system (e.g., guest user leaves the car of the host user). Some time later, the guest user may again enter the host user car, and the wireless device may automatically pair with the vehicle infotainment system. This may be problematic if the vehicle infotainment system has since been modified or otherwise compromised, with or without the knowledge of the host user. For example, the vehicle infotainment system may have been implanted with spoofing technology or been subject to a malicious software attack. As such, when the wireless device of the guest user automatically connects to the vehicle infotainment system without further authentication, it may be susceptible to unauthorized accesses for stealing user digital information, or implanting malicious software within the guest user device as well. As another example, the host user may position the vehicle within communication range of the guest user wireless device (e.g., guest user is home sleeping, host user pulls into driveway), creating an automatic device-to-device pairing. Thus, the wireless device may be accessible by the vehicle infotainment without the knowledge or consent of the guest user, allowing the host user to easily steal valuable digital information from the guest user wireless device.

Various embodiments enable more secure device-to-device communication pairing options for BT/BLE-enabled devices. In some embodiments, a user of a wireless device attempting to establish device-to-device communications may be provided with various operation modes, including a User Mode and a Guest Mode.

In some embodiments, the User Mode may be selected during the configuration of a first time connection between two devices. The devices may be paired using BT/BLE/etc. protocols, including one-time password (OTP) generation. The BT/BLE device ID may be stored/remembered, and subsequent connections may be automatically connected if BT/BLE is enabled and the devices are within range. The user of a wireless device in User Mode may terminate the device-to-device connection manually (e.g., forget/unpair network/device). If unpaired successfully, the wireless device will have to perform the initial authentication and handshaking protocols again to establish a subsequent connection.

In some embodiments, a Guest Mode may be provided to offer additional, selectable security options and features to enable a more secure device-to-device connection than a User Mode connection. In some embodiments, a Guest Mode may include a subset of user selectable features that may be implemented alone or in any combination with each other. This may allow a user to customize the access permissions and device-to-device communication security for various scenarios and with various devices. In some embodiments, a Guest Mode may include a one-time access/temporary connection type that is selectable to configure device-to-device communications. The one-time access/temporary connection type may be selected to temporarily store a device ID of a connected wireless device. Upon disconnection, the device ID may be deleted or otherwise forgotten by the wireless device, such that any subsequent connection attempts will not automatically connect and will have to reperform authentication procedures (e.g., OTP exchange) to establish a connection.

In some embodiments, a Guest Mode may include a limited features connection type that is selectable to configure device-to-device communications. The limited features connection type may be implemented to allow a user to select any number of features and/or data types available implemented on or stored within the user's wireless device, but with restricted access permissions. The selected features and/or data types may define the access permissions granted to a connected wireless device, such that the paired device is limited to accessing only the selected features/data, or alternatively, is limited to accessing only the features/data besides the selected features/data. In some embodiments, the limited features connection type may store the device ID of any paired wireless device. Thus, when a recognizable (i.e. device ID match) wireless device attempts to reconnect with a wireless device enforcing the Guest Mode restrictions, the wireless devices may automatically connect. However, the paired connection is automatically configured to enable the same limited features and/or data type restrictions as selected in a limited features configuration settings module. In some embodiments, limited feature/data access may be overridden and full (i.e. selected feature) access may be granted, either for the instant connection or for all future connections, if the user(s) wish to provide additional authentication.

In some embodiments, a Guest Mode may include an option to provide security alerts when attempting to establish a device-to-device connection. In some embodiments, a Guest Mode may include an alert connection type that is selectable to configure device-to-device communications. The alert connection type may be selected to allow automatic device-to-device connection with an alert and/or additional key/password authentication. For example, in an initial connection, a device ID of a connected wireless device may be stored, and subsequent connections may be auto connected. In some embodiments, a notification may be generated to alert the user of the connection in response to the automatic device-to-device connection. In some embodiments, the alert notification may include or otherwise be transmitted along with a request for additional authentication information to finalize the connection before access is granted. In some embodiments, attempted device-to-device connections may time-out and terminate if the additional authentication information is not received by the wireless device before the expiration of a timer/counter initiated at the time the access attempt is made.

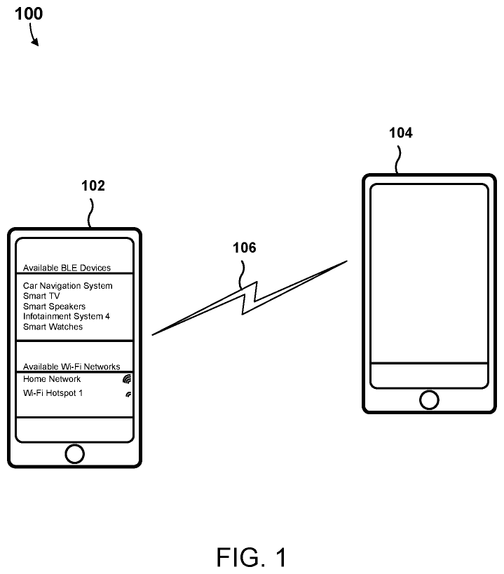

FIG. 1 is a system block diagram illustrating an example device-to-device communications system 100 according to some embodiments. The communications system 100 may be an 5G NR network, or any other suitable network such as an LTE network. The device-to-device communications system 100 may include wireless devices 102 and 104. The wireless devices 102 and 104 may establish a wireless communication link 106 to communicate various configuration and data signals between the wireless devices 102 and 104. The communication link 106 may implement various radio access technologies (RATs) such as BT and BLE to pair the wireless device 102 with the wireless device 104. Further examples of RATs that may be used in the wireless communication link 106 within the communications system 100 include medium range protocols such as Wi-Fi, LTE-U, LTE-Direct, LAA, MuLTEfire, and relatively short-range RATs such as ZigBee. For example, one or both of the wireless devices 102 and 104 may be configured as a Wi-Fi hotspot, enabling connected devices to access local area networks (LANs) and/or wide area networks (WANs).

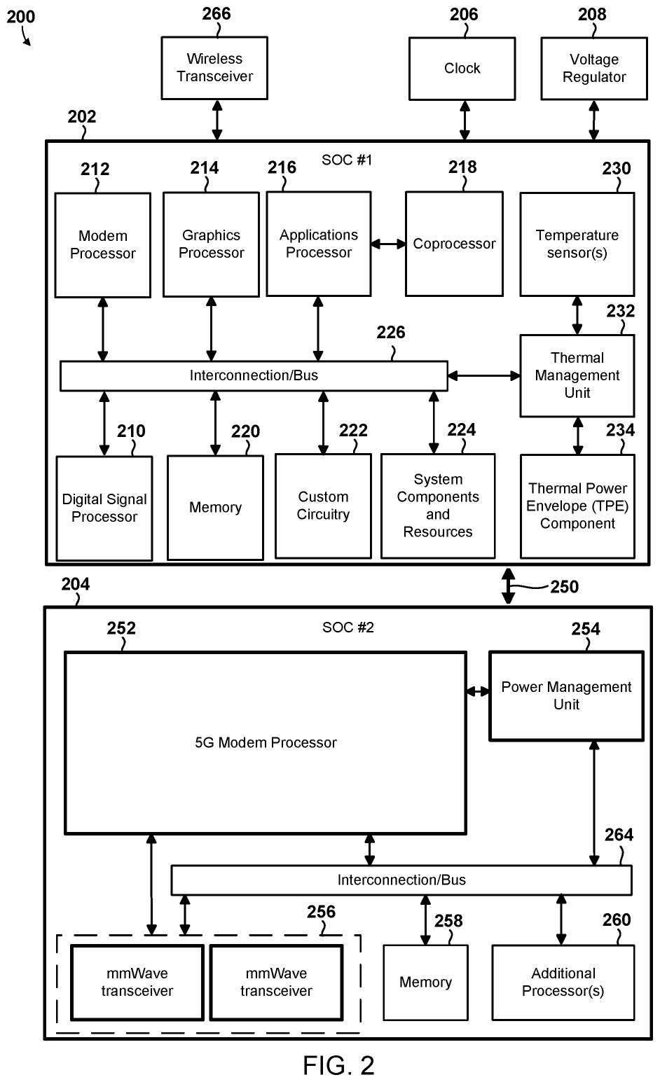

FIG. 2 is a component block diagram illustrating an example computing system 200 that may be configured to establish secure device-to-device communications between two wireless devices according to some embodiments. Various implementations may be implemented on a number of single processor and multiprocessor computer systems, including a SOC or a SIP. The example illustrated in FIG. 2 is a SIP 200 architecture that may be used in wireless devices and network devices implementing the various implementations.

With reference to FIGS. 1 and 2, the illustrated example SIP 200 includes two SOCs 202, 204, a clock 206, a voltage regulator 208 and a wireless transceiver 266. In some implementations, the first SOC 202 may operate as central processing unit (CPU) of the wireless device that carries out the instructions of software application programs by performing the arithmetic, logical, control and input/output (I/O) operations specified by the instructions. In some implementations, the second SOC 204 may operate as a specialized processing unit. For example, the second SOC 204 may operate as a specialized 5G processing unit responsible for managing high volume, high speed (such as 5 Gbps, etc.), or very high frequency short wave length (such as 28 GHz mmWave spectrum, etc.) communications.

The first SOC 202 may include a digital signal processor (DSP) 210, a modem processor 212, a graphics processor 214, an application processor 216, one or more coprocessors 218 (such as vector co-processor) connected to one or more of the processors, memory 220, custom circuitry 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 264, a plurality of mmWave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (such as FreeBSD, LINUX, OS X, etc.) and a processor that executes a second type of operating system (such as MICROSOFT WINDOWS 10). In addition, any or all of the processors 210, 212, 214, 216, 218, 252, 260 may be included as part of a processor cluster architecture (such as a synchronous processor cluster architecture, an asynchronous or heterogeneous processor cluster architecture, etc.). In some implementations, any or all of the processors 210, 212, 214, 216, 218, 252, 260 may be a component of a processing system. A processing system may generally refer to a system or series of machines or components that receives inputs and processes the inputs to produce a set of outputs (which may be passed to other systems or components of, for example, the first SOC 202 or the second SOC 250). For example, a processing system of the first SOC 202 or the second SOC 250 may refer to a system including the various other components or subcomponents of the first SOC 202 or the second SOC 250.

The processing system of the first SOC 202 or the second SOC 250 may interface with other components of the first SOC 202 or the second SOC 250. The processing system of the first SOC 202 or the second SOC 250 may process information received from other components (such as inputs or signals), output information to other components, etc. For example, a chip or modem of the first SOC 202 or the second SOC 250 may include a processing system, a first interface to output information, and a second interface to receive information. In some cases, the first interface may refer to an interface between the processing system of the chip or modem and a transmitter, such that the first SOC 202 or the second SOC 250 may transmit information output from the chip or modem. In some cases, the second interface may refer to an interface between the processing system of the chip or modem and a receiver, such that the first SOC 202 or the second SOC 250 may receive information or signal inputs, and the information may be passed to the processing system. A person having ordinary skill in the art will readily recognize that the first interface also may receive information or signal inputs, and the second interface also may transmit information.

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a wireless device. The system components and resources 224 or custom circuitry 222 also may include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates or implement a bus architecture (such as CoreConnect, AMBA, etc.). Communications may be provided by advanced interconnects, such as high-performance networks-on chip (NoCs).

The first or second SOCs 202, 204 may further include an input/output module (not illustrated) for communicating with resources external to the SOC, such as a clock 206 and a voltage regulator 208. Resources external to the SOC (such as clock 206, voltage regulator 208) may be shared by two or more of the internal SOC processors/cores.

In addition to the example SIP 200 discussed above, various implementations may be implemented in a wide variety of computing systems, which may include a single processor, multiple processors, multicore processors, or any combination thereof.

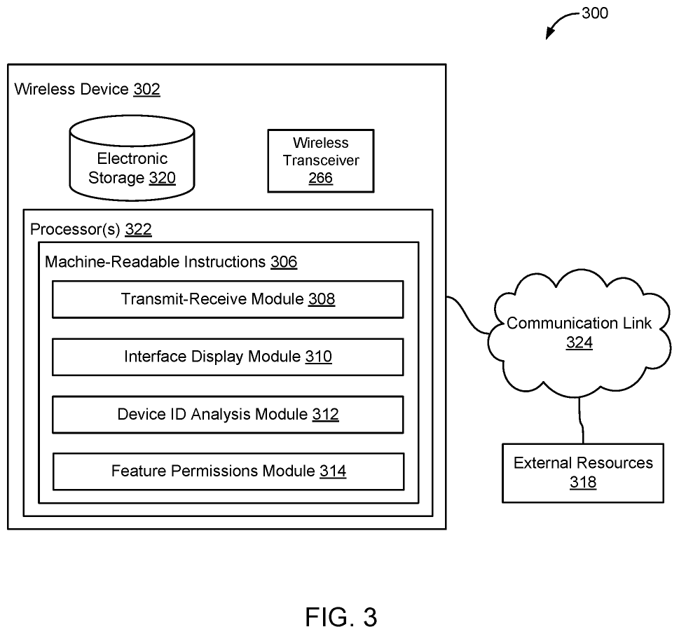

FIG. 3 is a component block diagram illustrating an example system 300 configured to establish secure device-to-device communications between two wireless devices according to some embodiments. With reference to FIGS. 1-3, the system 300 may include one or more wireless device(s) 302 (e.g., the wireless device(s) 102, 104, 202) and external resources 418, which may communicate via a wireless communication network 324. External resources 318 may include sources of information outside of the system 300, external entities participating with the system 300, or other resources. In some implementations, some or all of the functionality attributed herein to external resources 318 may be provided by resources included in the system 300.

The wireless device(s) 302 may be configured by machine-readable instructions 306. Machine-readable instructions 306 may include one or more instruction modules. The instruction modules may include computer program modules. The instruction modules may include one or more of a transmit-receive module 308, an interface display module 310, a device ID analysis module 312, a limited features configuration settings module 314, and other instruction modules (not illustrated). The wireless device 302 may include electronic storage 320 that may be configured to store information related to functions implemented by the transmit-receive module 308, the interface display module 310, the device ID analysis module 312, the limited features configuration settings module 314, and any other instruction modules. The wireless device 302 may include processor(s) 322 configured to implement the machine-readable instructions 306 and corresponding modules.

The transmit-receive module 308 may be configured to establish, configure, or otherwise maintain a wireless communications link with another wireless device, wireless network, or external resources 318. For example, the transmit-receive module 308 may implement device-to-device BLE communications, managing any handshaking protocols to establish the BLE connection and performing operations for transmitting and receiving data signals across the BLE connection. The transmit-receive module 308 may receive information from connected or paired wireless devices or networks including device IDs.

The interface display module 310 may be configured to operate a user interface display of a wireless device. The interface display module 310 may enable a wireless device to display various information, features, and/or data that may be presented to and/or are selectable by a user of the wireless device 302. For example, the interface display module 310 may display a user-selectable option to establish the wireless connection using a guest mode. As another example, the interface display module 310 may receive a selection to establish the wireless connection using the guest mode.

The device ID analysis module 312 may be configured to determine whether a received device ID from a paired or connected wireless device, or wireless device attempting to connect to the wireless device 302 matches a stored device ID in one or more databases.

The limited features configuration settings module 314 may be configured to receive and store selections of any features, applications, or data types implementable by or stored within the wireless device 302, a paired wireless device, or connected wireless network. For example, the limited features configuration settings module 314 may be configured to create and retain a list of selected features that a user desires to restrict access to during BLE communications with another wireless device.

In some embodiments, the electronic storage 320 may include one or more databases to implement some embodiments. For example, the electronic storage 320 may configure in separate memory spaces a user database, a limited features database, an alert database, and temporary storage space/memory address range(s). The various databases may be used to separately store device ID information and any associated information depending on the type of connection (e.g., User Mode, Guest Mode, one-time access, limited features access, alert access) configured by the user of the wireless device 302 during a current connection or previously terminated connection with a wireless device.

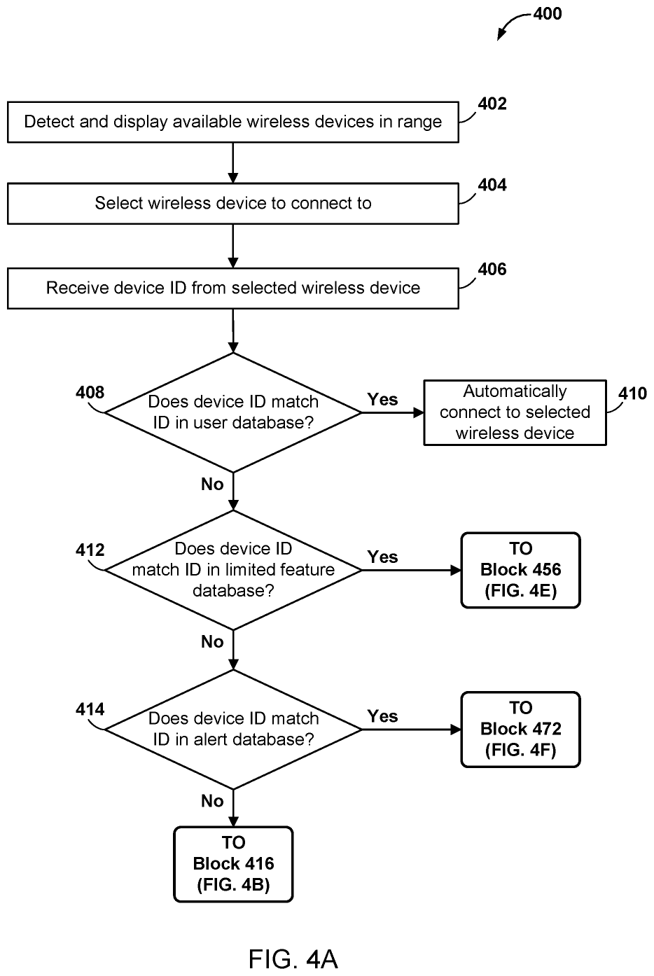

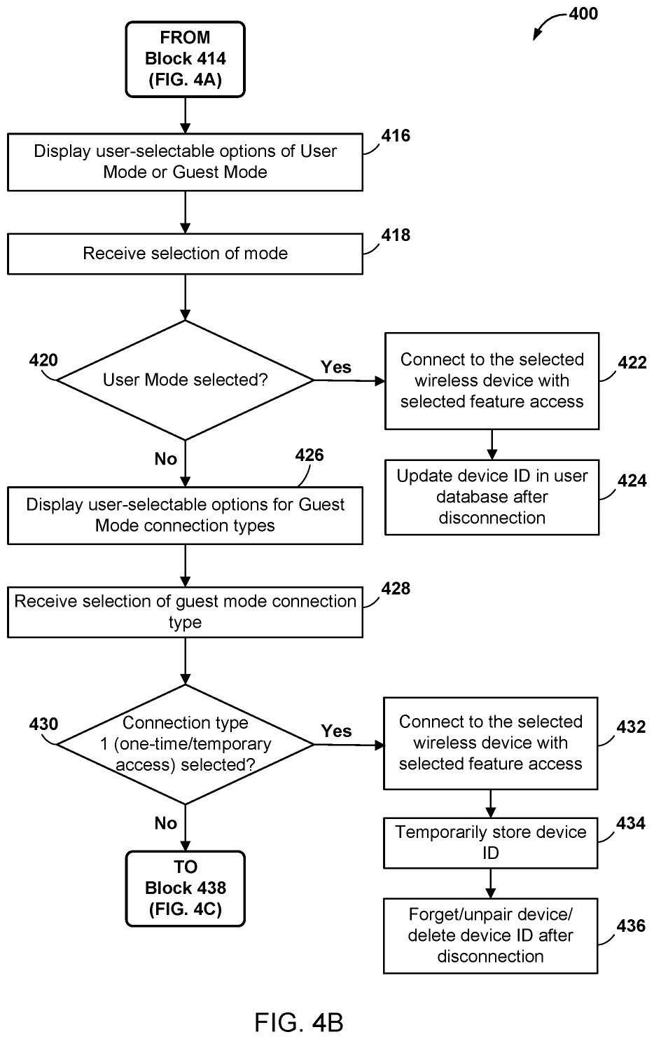

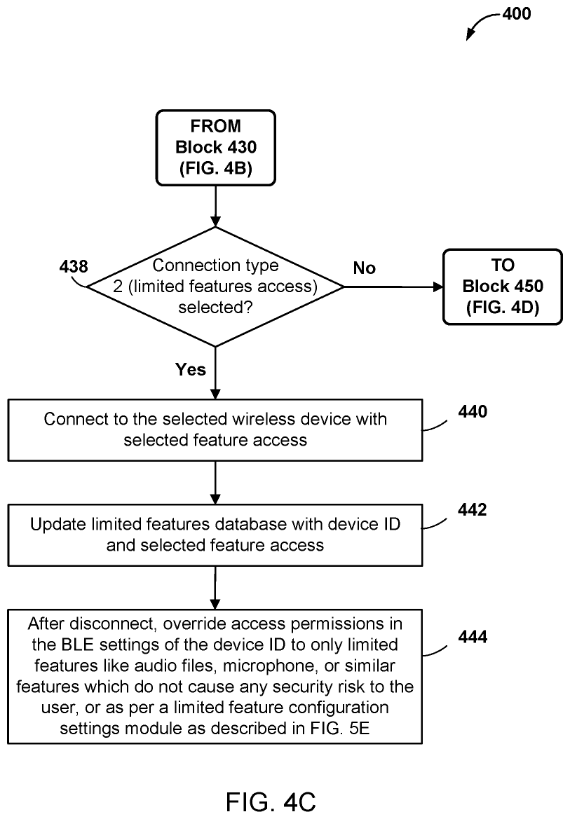

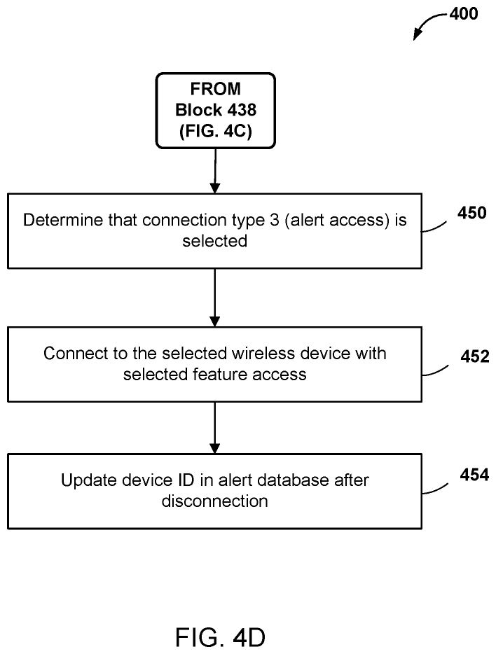

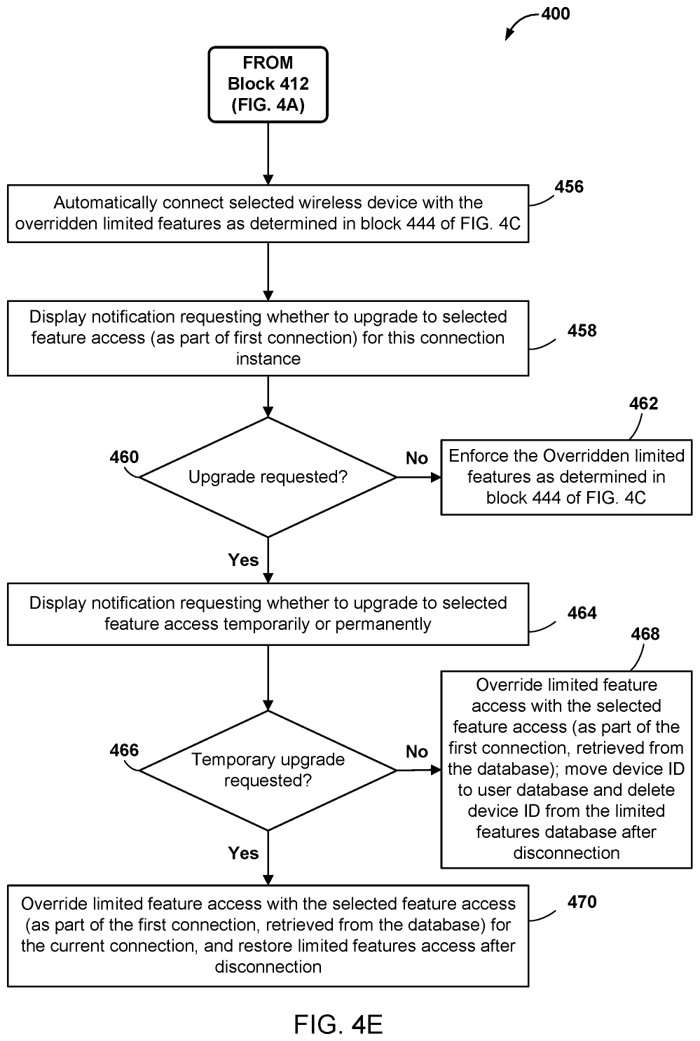

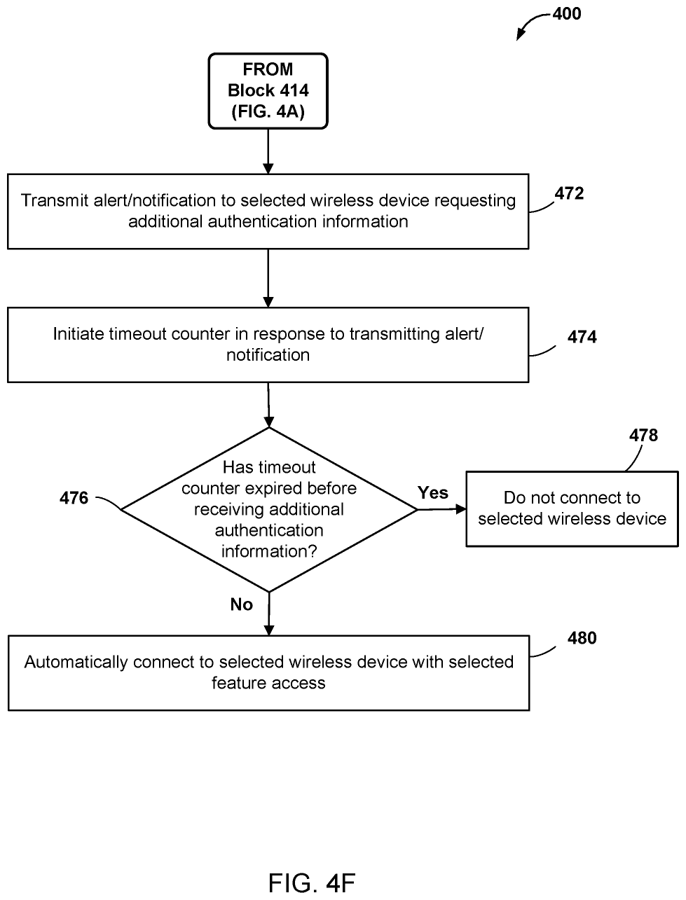

FIGS. 4A-4F are process flow diagrams of a method 400 for establishing secure device-to-device communications between two wireless devices according to some embodiments. With reference to FIGS. 1-4F, the method 400 may be implemented by a processor (e.g., processor 210, 212, 214, 216, 218, 252, 260) of a wireless device (e.g., the wireless device 102, 104, 202, 302)). In some embodiments, the term selected feature access may refer to full feature and/or data type access, or selective feature and/or data type access (i.e. a subset of full feature access configurable by a user in wireless device settings). For example, at the time of a first-time BT/BLE connection between a first wireless devices and a second wireless device, access permissions to the first wireless device, like call history, contacts, text data, audio files, camera application, photos, and other features or data, may be requested by the second wireless device. In this scenario, the user of the first wireless device may either allow all of the requested permission access or avoid some access permissions (e.g., call history and contacts) and allow other access permissions.

The order of operations performed in blocks 402-474 is merely illustrative, and the operations of blocks 402-418 may be performed in any order and partially simultaneously in some embodiments. In some embodiments, the method 400 may be performed by a processor of a device independently from, but in conjunction with, an external memory device. For example, the method 400 may be implemented as a software module executing within a processor of an SOC or in dedicated hardware within an SOC that issues commands to establish secure memory channels and access memory of an external memory device and is otherwise configured to take actions and store data as described.

In some embodiments, a wireless connection established between a user wireless device and a selected wireless device (e.g., as described in blocks 410, 422, 432, 444, 452, 456, and 474) may be established using any conventional wireless communication standard or protocol for establishing mid-to-short range wireless communications. For example, connections between a user wireless device and a selected wireless device may be establishing using an OTP exchange.

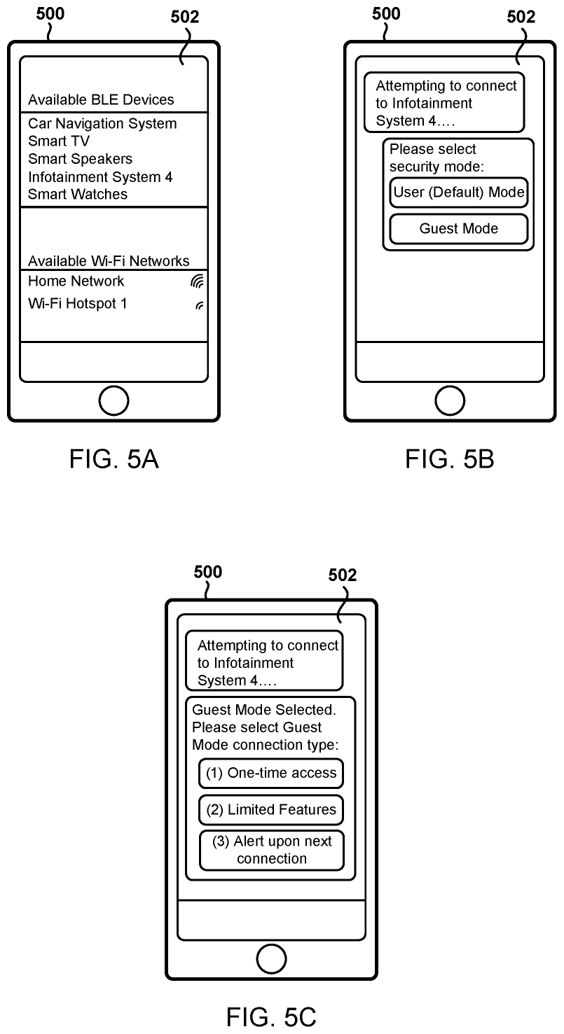

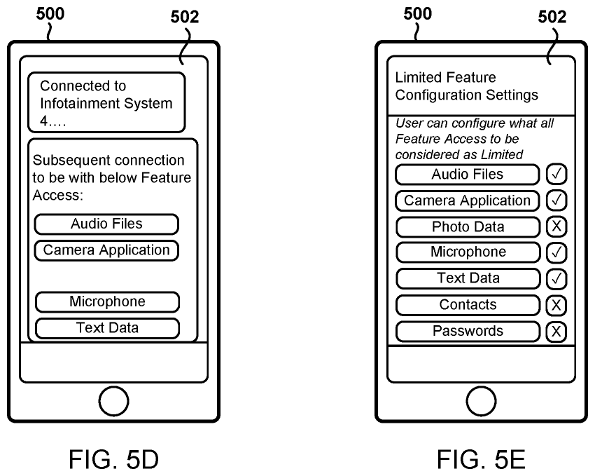

Referring to FIG. 4A, in block 402, a user wireless device may detect wireless devices within communication range that are available for establishing secure wireless communications, and then display the available wireless devices on a user interface display. The wireless device may detect available wireless devices, such as BLE enabled devices, wireless local area network (LAN) devices/networks, and/or Wi-Fi hotspots/network access points. The wireless device may display the available wireless devices and networks available within a user interface of the user wireless device. For example, FIGS. 5A-5E illustrate an example mobile device 500 (e.g., user wireless device) for displaying and receiving selections for establishing secure communications with another wireless device according to some embodiments. Referring to FIG. 5A, the mobile device 500 may detect and then display available wireless devices via a user interface 502. For example, the mobile device 500 may display available BLE devices, such as a car navigation system, smart TV, smart speakers, smart watches, or any other kind of infotainment system within detection range of the mobile device. The mobile device 500 may also display available Wi-Fi networks, such as a home network or a Wi-Fi hotspot within detection range of the mobile device 500.

Referring back to FIG. 4A, in block 404, the user wireless device may receive a selection of an available wireless device for attempting to establish a secure wireless connection. The user wireless device may receive, via a user interface, a selection of one of the detected wireless devices, in which the selection is made by a user of the user wireless device. For example, referring to FIG. 5A, the user of the mobile device 500 may tap on or otherwise touch the user interface 502 to select one of the detected wireless devices or networks.

In block 406, the user wireless device may receive a device ID or other identification information from the selected wireless device. For example, the selected wireless device may be a BLE-enabled device having a BLE device ID or tag information. The user wireless device may request and/or receive the BLE device ID for determining whether to automatically connect to the selected wireless device.

The purpose of the processes described in blocks 408, 412, and 414 is to determine whether the selected wireless device has made a previous secure connection with the user selected device. For example, the user selected device may store a device ID of any connected wireless device when connecting according to a User Mode (i.e. full/selected feature with automatic connection for subsequent connection attempts), Guest Mode with limited features and/or data access, or Guest mode with selected feature access selected as part of a first (i.e. initial) connection but requiring authentication upon subsequent connection attempts. The various device IDs corresponding to different wireless devices may be stored in separate databases (e.g., user database, limited features database, alert database) that the user wireless device may compare against a received device ID. In some embodiments, the processes described in determination blocks 408, 412, and 414 may be determined in any order. In some embodiments, the processes described in determination blocks 408, 412, and 414 may be performed in a single block to determine if the received device ID for the current access attempt corresponds to any stored device ID, and if so, to determine the type of access mode (User Mode, Guest Mode) to enforce with corresponding access permissions (e.g., limited features, requires additional authentication upon subsequent access attempts) granted to the selected wireless device.

In determination block 408, the user wireless device may determine whether the device ID received from the selected wireless device matches a device ID within a user database of the user wireless device. In some embodiments, the user wireless device may include a repository or database including any device IDs or identification information corresponding to any previously connected wireless devices. The user database may store or otherwise include instructions to store device IDs or identification information corresponding to wireless devices that have been previously connected to the user wireless device using a User Mode, or default access connection without restrictions. In other words, the user database of the user wireless device may include device IDs corresponding to wireless devices that have been granted full access or selected feature access selected as part of a first connection to the user wireless device in a prior wireless connection that has since been disconnected. For example, the user database may store a device ID corresponding to a BLE-enabled device after unpairing with the BLE-enabled device, in which the previous pairing with the BLE-enabled device was an unrestricted access pairing.

In response to determining that the received device ID matches a device ID within the user database of the user wireless device (i.e., determination block 408=“Yes”), the user wireless device may automatically connect to the selected wireless device as described in block 410. Determining that the received device ID matches a device ID within the user database may signify that the selected wireless device was previously granted selected/full access to the features and data of the user wireless device, and that no further authentication may be necessary for establishing a secure connection between the devices.

In response to determining that the received device ID does not match a device ID within the user database of the user wireless device (i.e., determination block 408=“No”), the user wireless device may determine whether the received device ID matches a device ID in a limited feature database as described in determination block 412.

In determination block 412, the user wireless device may determine whether the device ID received from the selected wireless device matches a device ID within a limited features database of the user wireless device. In some embodiments, the user wireless device may include a repository or database including any device IDs or identification information corresponding to any previously connected wireless devices that were granted only limited access to the user wireless device features and/or data. The limited features database may store or otherwise include instructions to store device IDs or identification information corresponding to wireless devices that have been previously connected to the user wireless device using a Guest Mode enforcing limited access to features of the user wireless device. In other words, the limited features database of the user wireless device may include device IDs corresponding to wireless devices that have been granted limited access to the user wireless device in a prior wireless connection that has since been disconnected. For example, the limited features database may store a device ID corresponding to a BLE-enabled device after unpairing with the BLE-enabled device, in which the previous pairing with the BLE-enabled device was a restricted access pairing. In some embodiments, the limited features database may store, in association with a corresponding device ID, the features access selected and/or enabled during the first-time connection establishment.

In response to determining that the received device ID matches a device ID within the limited features database of the user wireless device (i.e., determination block 412=“Yes”), the user wireless device may perform processes as described in blocks 456-470 of FIG. 4E. Determining that the received device ID matches a device ID within the limited features database may signify that the selected wireless device was previously or should be granted limited access to the features and data of the user wireless device, and that no further authentication may be necessary for establishing a secure, yet limited, connection between the devices.

Referring to FIG. 4E, in block 456, the user wireless device may automatically connect to the selected wireless device with the overridden limited features, such as audio files, microphone, or similar features that do not cause security risk to the user, as determined in block 444 of FIG. 4C. In some embodiments, the automatic connection to the selected wireless device may be based on the limited features selected as part of a limited features configuration settings module as described in FIG. 5E. Until otherwise specified, the user wireless device may enforce the overridden limited features and restricted access associated with the matched device ID.

In block 458, the user wireless device may display a notification requesting a selection on whether to upgrade to selected feature access (as part of first connection) for this connection instance, as opposed to the limited features granted upon identification of the associated device ID of the selected wireless device. For example, the notification may be displayed to a user of the user wireless device to prompt a selection of upgrading to selected features access selected as part of the first connection for this instant connection, or to keep limited access.

In determination block 460, the user wireless device may determine whether upgrade to selected feature access was requested by the user of the user wireless device. For example, the user wireless device may determine that selected feature access was requested or not requested based on a selection made by the user via the user interface display of the user wireless device.

In response to determining that upgrading to selected features access (selected as part of the first connection) was not requested by the user of the user wireless device, (i.e., determination block 460=“No”), the user wireless device may enforce the overridden limited features (i.e. as determined in block 444 of FIG. 4C) that were previously selected as part of limited features configuration settings (i.e. via the limited features configurations settings module) in block 462. For example, the user wireless device may enforce, until disconnection, the same limited features accessible by the selected wireless device that were accessible by the selected wireless device in a previous connection.

In response to determining that upgrading to selected features access (selected as part of the first connection) was requested by the user of the user wireless device, (i.e., determination block 460=“Yes”), the user wireless device may display a notification requesting a selection on whether to upgrade to selected feature access (as part of first connection) temporarily for this connection instance, or permanently for this connection instance and all future connections as described in block 464. For example, the user may request temporary upgraded access, in which selected feature access may be granted for the current connection, but not for any subsequent automatic connections after disconnecting (i.e. selected feature access is reverted to limited feature access). The user may request permanent upgrade access, in which selected feature access may be granted for the current connection and all subsequent automatic connections.

In determination block 466, the user wireless device may determine whether temporary upgrade to selected feature access was requested by the user of the user wireless device. For example, the user wireless device may determine that temporary upgrade to selected feature access was requested or that permanent upgrade to selected features access was requested based on a selection made by the user via the user interface display of the user wireless device.

In response to determining that temporary upgrade to selected feature access was not requested by the user of the user wireless device, (i.e., determination block 466=“No”) and that permanent upgrade to selected feature access was requested, the user wireless device may override limited feature access with the selected feature access (as part of the first connection, retrieved from the database), and may, after disconnection, move the device ID to the user database and delete the device ID from the limited features database as described in block 468. For example, if permanent upgrade to selected feature access is requested, the user wireless device may store the device ID in the user database and may delete the same device ID from the limited features database. This will enable the user wireless device to automatically connect to the selected wireless device for any subsequent connections according to the processes described in block 408 and 410 of the method 400 (FIG. 4A). In other words, the permanent upgrade to selected feature access may involve upgrading the access permissions from a Guest Mode with a limited feature connection type to a User Mode.

In response to determining that temporary upgrade to selected feature access was requested by the user of the user wireless device (i.e., determination block 466=“Yes”) and that permanent upgrade to selected feature access was not requested, the user wireless device may override limited feature access with the selected feature access (as part of the first connection, retrieved from the database) for the current connection, and may restore limited features access after disconnection as described in block 470. After terminating a connection in which access to the user selected device by the selected wireless device was temporarily upgraded to selected feature access, any subsequent access attempts may repeat the operations in blocks 456 through 470 as described to determine whether the restrictions associated with the stored device ID should be again overridden. For example, the user wireless device may enforce, until disconnection, the selected features accessible by the selected wireless device that were accessible by the selected wireless device in the first connection establishment according to the permission stored in the limited features database in association with the device ID.

Referring back to block 412 of FIG. 4A, in response to determining that the received device ID does not match a device ID within the limited features database of the user wireless device (i.e., determination block 412=“No”), the user wireless device may determine whether the received device ID matches a device ID in an alert database as described in determination block 414.

In determination block 414, the user wireless device may determine whether the device ID received from the selected wireless device matches a device ID within an alert database of the user wireless device. In some embodiments, the user wireless device may include a repository or database including any device IDs or identification information corresponding to any previously connected wireless devices that were granted only limited reconnection access to the user wireless device features and/or data. The alert database may store or otherwise include instructions to store device IDs or identification information corresponding to wireless devices that have been previously connected to the user wireless device using a Guest Mode requiring an alert and/or additional authentication upon subsequent reconnections. In other words, the alert database of the user wireless device may include device IDs corresponding to wireless devices that have been granted default or selected feature access to the user wireless device in a prior wireless connection that has since been disconnected. For example, the alert database may store a device ID corresponding to a BLE-enabled device after unpairing with the BLE-enabled device, in which the previous pairing with the BLE-enabled device was a full/selected feature access pairing. In some embodiments, the alert database may store, in association with a corresponding device ID, an instruction to be executed upon any subsequent access attempts by the same selected wireless device. The instruction may include an alert to a user of the user wireless device and/or the selected wireless device, and/or a request for additional authentication before granting access permissions to the selected wireless device.

In response to determining that the received device ID matches a device ID within the alert database of the user wireless device (i.e., determination block 414=“Yes”), the user wireless device may perform processes as described in blocks 472-480 of FIG. 4F. Determining that the received device ID matches a device ID within the alert database may signify that the selected wireless device was previously granted full/selected access to the features and data of the user wireless device in a Guest Mode, but that any subsequent connections to the selected wireless device may require an alert or notification to one or more users, and/or additional authentication information before granting full/selected feature access again.

Referring to FIG. 4F, in block 472, the user wireless device may transmit an alert or notification to the selected wireless device requesting additional authentication information before granting the selected wireless full/selected access to the features and/or data of the user wireless device. Until the additional authentication information is provided, the features and data of the user wireless device may remain protected and secure from the selected wireless device (i.e. the connection is not established, or permissions are not granted). In some embodiments, the alert or notification may be output to a user interface of the user wireless device, prompting the user to provide additional authentication information and/or prompt a request to the selected wireless device for additional authentication information.

In block 474, the user wireless device may initiate a timeout counter in response to transmitting the alert or notification to the selected wireless device. For example, the timeout counter may count up to or down from a predefined period (e.g., 10 seconds) before determining that a potential connection with the selected wireless device should be abandoned for security and power conservation purposes.

In determination block 476, the user wireless device may determine whether the timeout counter expired before receiving the additional authentication information from the selected wireless device.

In response to determining that the timeout counter expired before receiving the additional authentication information from the selected wireless device, (i.e., determination block 476=“Yes”), the user wireless device may terminate ongoing wireless connection protocols (BLE/Wi-Fi handshaking), preventing the selected wireless device from establishing a connection with the user wireless device as described in block 478.

In response to determining that the timeout counter did not expired before receiving the additional authentication information from the selected wireless device, (i.e., determination block 476=“No”), the user wireless device may automatically connect to selected wireless device with selected feature access via wireless connection protocols (BLE/Wi-Fi handshaking) as described in block 480.

Referring back to block 414 of FIG. 4A, in response to determining that the received device ID does not match a device ID within the alert database of the user wireless device (i.e., determination block 412=“No”), the user wireless device may display user-selectable options for configuring the user wireless device in a User Mode or a Guest Mode as described in block 416 of FIG. 4B.

Determining that the received device ID from the selected wireless device may signify that the selected wireless device has not been connected to the user wireless device previously, or that the selected wireless device was previously connected using a one-time access Guest Mode configuration, such that the device ID was temporarily stored and then deleted from the user wireless device.

In block 416, the user wireless device may display options to allow a user or the user wireless device to select a User Mode or a Guest Mode. For example, referring to FIG. 5B, a user of the mobile device 500 may select to establish a connection with the selected wireless device using a User Mode or a Guest Mode via the user interface 502.

In block 418, the user wireless device may receive a selection of the desired mode (i.e. User Mode, Guest Mode) to use in establishing the connection with the selected wireless device.

In determination block 420, the user wireless device may determine whether the User Mode was selected by the user of the user wireless device.

In response to determining that the User Mode option was selected by the user of the user wireless device, (i.e., determination block 420=“Yes”), the user wireless device may connect to the selected wireless device with selected feature access (i.e., full/selected Feature access) as described in block 422. In some embodiments, the user wireless device may establish a connection granting the selected wireless device full/selected access to any features provided by or data stored on the user wireless device. In some embodiments, the user wireless device may establish a connection configuring the selected wireless device to grant the user wireless device full/selected access permissions to any features provided by or data stored on the selected wireless device.

In block 424, the user wireless device may update the device ID in the user database after disconnecting with the selected wireless device. Storing the device ID received from the selected wireless device may allow the user wireless device to identify and automatically connect the selected wireless device during any future access attempts (e.g., as described in blocks 408 and 410).

In response to determining that the User Mode option was not selected by the user of the user wireless device, (i.e., determination block 420=“No”), the user wireless device may display user-selectable options for Guest Mode connection types as described in block 426. Determining that the User Mode option was not selected during the processes described in block 420 may indicate that the Guest Mode option was selected by the user of the user wireless device. Guest Mode connection types may include a one-time/temporary access connection (i.e. Guest Mode 1), a limited features access connection (i.e. Guest Mode 2), and an alert access connection (i.e. Guest Mode 3). The various Guest Mode connection types may be displayed on a user interface of the user wireless device. For example, referring to FIG. 5C, the mobile device 500 may display various Guest Mode connection types on the user interface 502, in which the Guest Mode connection types are selectable by a user of the user wireless device.

In block 428, the user wireless device may receive a selection of one of the Guest Mode selection types displayed on the user interface of the user wireless device. For example, the user may either select a one-time/temporary access connection resulting in a one-time access connection by the selected wireless device (i.e. processes performed in blocks 432-436 may be performed to define access permissions for a single established connection). After terminating the connection, the device ID may be deleted according to the one-time/temporary access connection type. As another example, the user may select an alert connection type to establish a connection instance with the selected wireless device that may produce an alert and/or require additional authentication information for future connection attempts (i.e. processes performed in blocks 450-454 and may be performed to define limited access permissions for current and future established connections).

In determination block 430, the user wireless device may determine whether the Guest Mode connection type 1, or one-time/temporary access, was selected by the user of the user wireless device.

In response to determining that the Guest Mode connection type 1, or one-time/temporary access, was selected by the user of the user wireless device, (i.e., determination block 430=“Yes”), the user wireless device may connect to the selected wireless device with selected feature access as described in block 432. In some embodiments, the user wireless device may establish a connection granting the selected wireless device full access to any-provided by or data stored on the user wireless device.

In block 434, the user wireless device may temporarily store the device ID.

In block 436, the user wireless device may delete the device ID, and otherwise forget/unpair the selected wireless device after termination of the established wireless connection. Thus, the user wireless device may not recognize, and may therefore not automatically connect to, the same selected wireless device for any subsequent connection attempts. This one-time access connection may provide the user wireless device with increased security such that future connections to the selected wireless device may require receiving active selections (e.g., blocks 404, 418, 428) by the user of the user wireless device, therefore preventing access to the features or data of the user wireless device without knowledge of the user.

In response to determining that the Guest Mode connection type 1, or one-time/temporary access, was not selected by the user of the user wireless device, (i.e., determination block 430=“No”), the user wireless device may determine whether the Guest Mode connection type 2, or limited features access, was selected by the user of the user wireless device as described in determination block 438 of FIG. 4C.

In response to determining that the Guest Mode connection type 2, or limited features access, was selected by the user of the user wireless device, (i.e., determination block 438=“Yes”), the user wireless device may connect to the selected wireless device with selected feature access in block 440 as described. The user wireless device may connect to the selected wireless device with the selected features and/or data types as per the existing BLE connection establishment protocol. In some embodiments, the user wireless device may establish a connection granting the selected wireless device access to the selected features and/or data types stored on the user wireless device. In some embodiments, the user wireless device may establish a connection configuring the selected wireless device to grant the user wireless device access permissions to the selected features and/or data types stored on the selected wireless device.

In some embodiments, the various features and data on the user wireless device available for potential access may be displayed on a user interface of the user wireless device. For example, referring to FIG. 5D, the mobile device 500 may display various features and data (e.g., audio files, camera application, photo data, microphone access, text data, etc.) on the user interface 502, in which the displayed features and data are the only accessible features (limited features) for subsequent connections. In some embodiments, once a user has selected a “Limited Feature Access” option for the BLE connection, subsequent connections will be performed using the displayed feature access only, which was previously configured by the user using the limited features configuration access module. For example, photo data (not shown) may be removed from the list of displayed features (e.g., audio files, camera application, microphone, text data) if it was not selected by the user in the limited features configuration settings module.

In some embodiments, the set of various features and data on the user wireless device available for potential access may be selected by a user before any connection attempts are performed. For example, a user may access a limited feature configuration settings module including a list of available features and/or data types implemented on the user wireless device. For example, referring to FIG. 5E, the mobile device 500 may display user wireless device configuration settings including various features and data (e.g., audio files, camera application, photo data, microphone access, text data, etc.) on the user interface 502, in which the available features and data are selectable by a user of the user wireless device. The mobile device 500 may display a limited features configuration module including selectable features to grant or restrict access to in future BLE connections, or otherwise implement a limited features configuration module to display selectable features to grant or restrict access to in future BLE connections. The user may select and save one or more features and/or data types to be accessible or not accessible in preparation of configuring any future connections when a Guest Mode with limited feature access is selected by the user. In other words, a connection attempt implementing a Guest Mode with limited features may be automatically established according to the limited features configuration settings module information. In some embodiments, the user may configure the limited features for a Guest mode with limited features access in the user wireless device BLE/Wi-Fi configuration settings as described with reference to FIG. 5E.

In some embodiments, the user wireless device may receive a user selection of one or more features and/or data types implemented by the user wireless device. In some embodiments, the received selection of features and/or data types may indicate which features and/or data types a user wants to make accessible (i.e. granting access permission to) to the selected wireless device during an established communication with the user wireless device. Therefore, non-selected features and/or data types may be restricted from and inaccessible by the selected wireless device. In some embodiments, the received selection of features and/or data types may indicate which features/data types a user does not want to make accessible (i.e. restricting access permission to) to the selected wireless device during an established communication with the user wireless device. Therefore, non-selected features and/or data types may be restricted by the selected wireless device.

In block 442, the user wireless device may update the limited features database with the received device ID of the selected wireless device and the selected feature access (i.e. selected features and/or data types). In some embodiments, the selected features and/or data types may be stored in the limited feature database in association with the device ID such that identification or retrieval of a device ID within the limited features database may also identify or retrieve the corresponding selected limited features and/or data types. Storing the device ID and corresponding selected limited features may allow the user wireless device to identify and automatically connect the selected wireless device during future connection attempts if upgrade is requested, such that the selected wireless device is granted access only to the limited features and/or data selected in the prior connection (e.g., as described in blocks 412, and 456-470).

In block 444, after disconnecting, the user wireless device may override access permissions in the BLE settings of the device ID to only limited features, like audio files, microphone access, or similar features that do not cause any security risks to the user or as per a limited features configuration settings module as describe in FIG. 5E. In some embodiments, limited features that may not pose security ricks may be automatically enabled upon reconnecting with the selected wireless device. In some embodiments, the low-security risk limited features may be configurable by a user of the user wireless device (e.g., user may select from a list of allowable low-security risk features using a limited features configuration settings module as describe in FIG. 5E), or may be automatically selected by the user wireless device. For example, the user wireless device may determine low-risk features and/or data types (e.g., microphone, audio files) from all available features and data types implemented on the user wireless device, and select those features and/or data types for allowable access upon reconnect, while automatically blocking access to high-risk features and/or data types (e.g., saved photographs, password information, contacts list) upon reconnect. In some embodiments, the user wireless device may enforce the access permissions within the user wireless device according to the selected limited features and/or data types. In some embodiments, the user wireless device may configure the selected wireless device to enforce access permissions within the selected wireless device according to the selected limited features and/or data types.

In response to determining that the Guest Mode connection type 2, or limited features access, was not selected by the user of the user wireless device, (i.e., determination block 438=“No”), the user wireless device may determine that the Guest Mode connection type 3, or alert access, was selected by the user of the user wireless device as described in block 450 of FIG. 4D.

In block 452, the user wireless device may connect to the selected wireless device with selected feature access. In some embodiments, the user wireless device may establish a connection granting the selected wireless device full/selected access to any features provided by or data stored on the user wireless device.

In block 454, the user wireless device may update the device ID in the alert database after disconnecting with the selected wireless device. Storing the device ID received from the selected wireless device may allow the user wireless device to identify and automatically connect the selected wireless device during any future access attempts (e.g., as described in blocks 414, and 472-480).

In some embodiments, the user wireless device may be configured to enable a User Mode or Guest Mode with full access or varying restrictions/limited features on the user wireless device itself (i.e. limiting the features and/or data of the user wireless device that the selected wireless device has access to) as described with reference to FIGS. 4A-4F. In some embodiments, the user wireless device may configure the selected wireless device enabling a User Mode or Guest Mode with full access or varying restrictions/limited features on the selected wireless device instead of the user wireless device (i.e. limiting the features and/or data of the selected wireless device that the user wireless device has access to). As such, various features, processes, components, and/or databases implemented on or by the user wireless device may be implemented by the user selected device to perform the same processes as described in FIGS. 4A-4F.

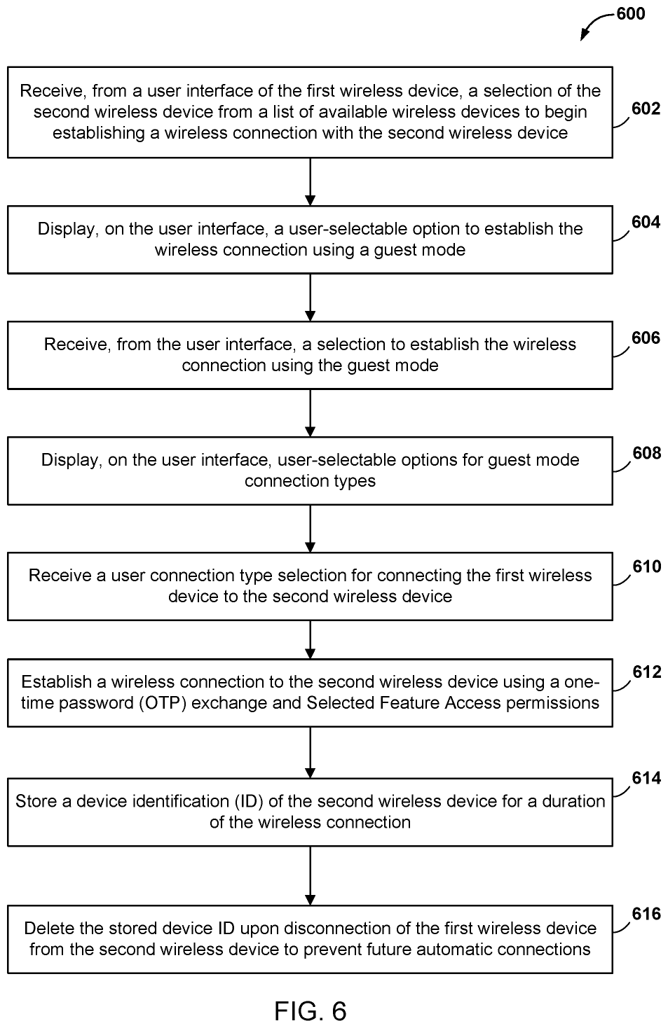

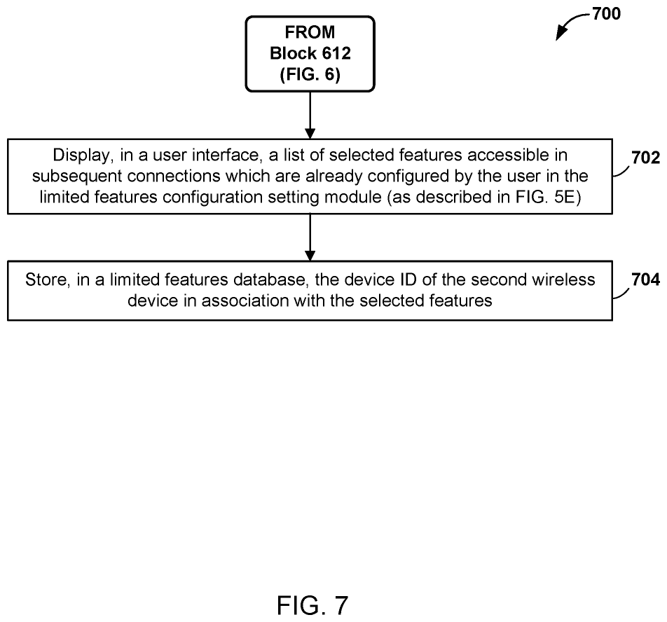

FIG. 6 is a process flow diagram illustrating a method 600 for establishing secure device-to-device communications between two wireless devices according to some embodiments. With reference to FIGS. 1-6, the method 600 may be performed by a processor (e.g., processor 210, 212, 214, 216, 218, 252, 260) of a wireless device (e.g., the wireless device 102, 104, 202, 302).

The order of operations performed in blocks 602-616 is merely illustrative, and the operations of blocks 602-616 may be performed in any order and partially simultaneously in some embodiments. In some embodiments, the method 600 may be performed by a processor of a wireless device independently from, but in conjunction with, a processor of another wireless device. For example, the method 600 may be implemented as a software module executing within a processor of an SOC or in dedicated hardware within an SOC that issues commands to attempt to establish secure device-to-device communications with the external wireless device and is otherwise configured to take actions and store data as described.

In block 602, the processor may perform operations including receiving, from a user interface of the first wireless device, a selection of the second wireless device from a list of available wireless devices to begin establishing a wireless connection with the second wireless device.

In block 604, the processor may perform operations including displaying, on the user interface, a user-selectable option to establish the wireless connection using a guest mode.

In block 606, the processor may perform operations including receiving, from the user interface, a selection to establish the wireless connection using the guest mode.

In block 608, the processor may perform operations including displaying, on the user interface, user-selectable options for guest mode connection types.

In block 610, the processor may perform operations including receiving a connection type selection by a user for connecting the first wireless device to the second wireless device.

In block 612, the processor may perform operations including establishing a wireless connection to the second wireless device using an OTP exchange and selected feature access permissions as per the existing BLE connection protocol.

In block 614, the processor may perform operations including storing a device ID of the second wireless device for a duration of the wireless connection. In some embodiments, the processes performed in block 614 may be performed in response to determining that a user selected connection type is a one-time temporary access connection type.

In block 616, the processor may perform operations including deleting the stored device ID upon disconnection of the first wireless device from the second wireless device to prevent future automatic connections. In some embodiments, the processes performed in block 616 may be performed in response to determining that a user selected connection type is a one-time temporary access connection type.

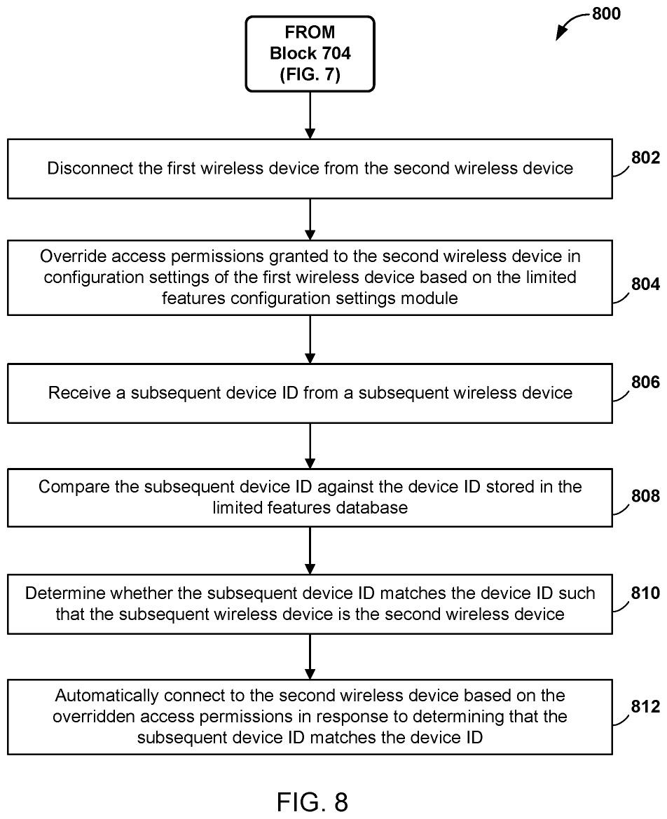

FIG. 7 is a process flow diagram illustrating alternative operations that may be performed by a processor of a wireless device as part of the method 600 for establishing secure device-to-device communications between two wireless devices according to some embodiments. With reference to FIGS. 1-7, the operations of the method 700 may be performed by a processor (e.g., processor 210, 212, 214, 216, 218, 252, 260) of a wireless device (e.g., the wireless device 102, 104, 202, 302). The processes described in block 702-704 may be performed in response to determining that the user selected connection type is a limited feature access connection type.

Following the performance of the operations of block 612 of the method 600 (FIG. 6), the processor may perform operations including displaying, in the user interface, a list of selected features accessible in subsequent connection which are already configured by the user in the limited features configuration settings module (e.g., as illustrated in FIG. 5E) as described in block 702.

In block 704, the processor may perform operations including storing, in a limited features database, the device ID of the second wireless device in association with the selected features. In some embodiments, the database may be a limited features database capable of storing a device ID and any associated selected features and/or data types selected by a user during the first-time device-to-device connection.

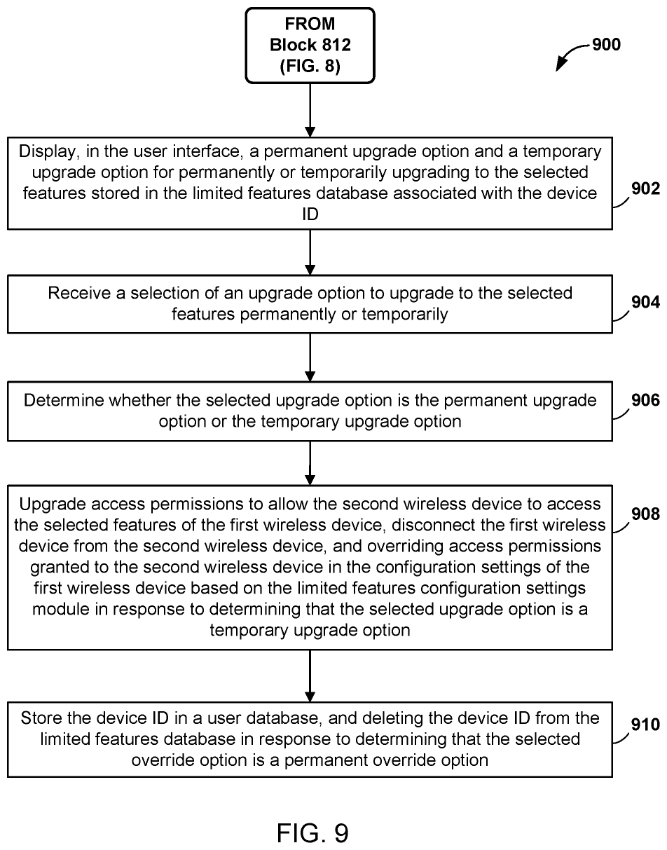

FIG. 8 is a process flow diagram illustrating alternative operations that may be performed by a processor of a wireless device as part of the method 600 for establishing secure device-to-device communications between two wireless devices according to some embodiments. With reference to FIGS. 1-8, the operations of the method 800 may be performed by a processor (e.g., processor 210, 212, 214, 216, 218, 252, 260) of a wireless device (e.g., the wireless device 102, 104, 202, 302). The processes described in block 802-812 may be performed in response to determining that the user selected connection type is a limited feature access connection type.

Following performance of the operations of block 704 of the method 700 (FIG. 7), the processor may perform operations including disconnecting the first wireless device from the second wireless device in block 802.

In block 804, the processor may perform operations including overriding access permissions granted to the second wireless device in configuration settings of the first wireless device based on the limited features configuration settings module. In some embodiments, the configuration settings may be BLE configuration settings. In some embodiments, the overriding access permissions granted to of the second wireless device in configuration settings of the first wireless device may be based at least on one or more on the selected features stored in the limited features database by the limited features configuration settings module.

In block 806, the processor may perform operations including receiving a subsequent device ID from a subsequent wireless device.

In block 808, the processor may perform operations including comparing the subsequent device ID against the device ID stored in the limited features database.

In block 810, the processor may perform operations including determining whether the subsequent device ID matches the device ID, which would indicate that the subsequent wireless device is the second wireless device.

In block 812, the processor may perform operations including automatically connecting to the second wireless device based on the overridden access permissions in response to determining that the subsequent device ID matches the device ID.

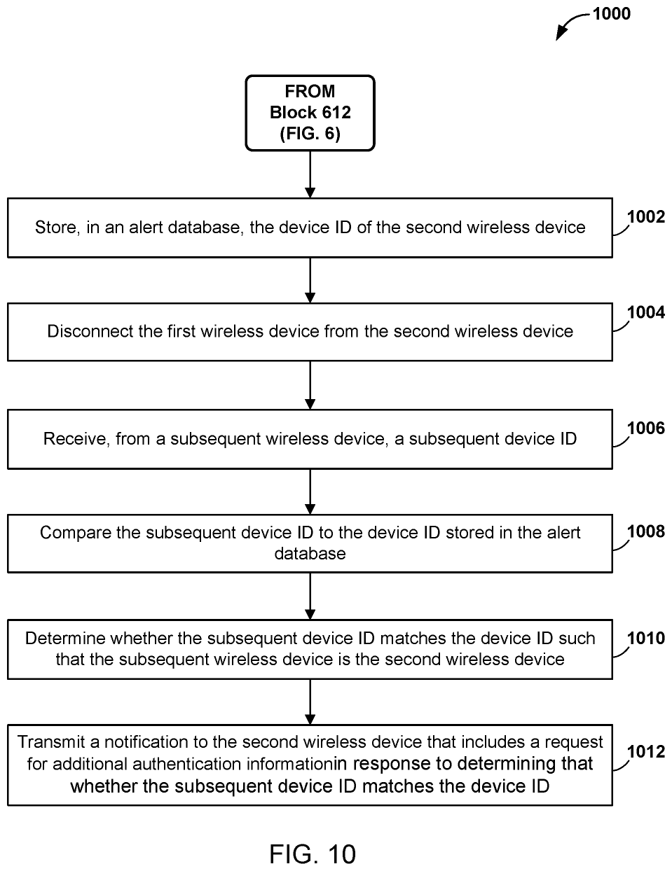

FIG. 9 is a process flow diagram illustrating alternative operations that may be performed by a processor of a wireless device as part of the method 600 for establishing secure device-to-device communications between two wireless devices according to some embodiments. With reference to FIGS. 1-9, the operations of the method 900 may be performed by a processor (e.g., processor 210, 212, 214, 216, 218, 252, 260) of a wireless device (e.g., the wireless device 102, 104, 202, 302). The processes described in block 902-910 may be performed in response to determining that the user selected connection type is a limited feature access connection type.

Following performance of the operations of block 812 of the method 800 (FIG. 8), the processor may perform operations including displaying, in the user interface, a permanent upgrade option and a temporary upgrade option for permanently or temporarily upgrading to the selected features stored in the limited features database associated with the device ID in block 902.

In block 904, the processor may perform operations including receiving a selection of an upgrade option to upgrade to the selected features permanently or temporarily.

In block 906, the processor may perform operations including determining whether the selected upgrade option is the permanent upgrade option or the temporary upgrade option.

In block 908, the processor may perform operations including upgrading access permissions to allow the second wireless device to access to the selected features of the first wireless device, disconnecting the first wireless device from the second wireless device, and overriding access permissions granted to the second wireless device in the configuration settings of the first wireless device based on the limited features configuration settings module in response to determining that the selected upgrade option is a temporary upgrade option.

In block 910, the processor may perform operations including storing the device ID in a user database and deleting the device ID from the limited features database in response to determining that the selected upgrade option is a permanent upgrade option.

FIG. 10 is a process flow diagram illustrating alternative operations 800 that may be performed by a processor of a wireless device as part of the method 600 for establishing secure device-to-device communications between two wireless devices according to some embodiments. With reference to FIGS. 1-10, the operations of the method 1000 may be performed by a processor (e.g., processor 210, 212, 214, 216, 218, 252, 260) of a wireless device (e.g., the wireless device 102, 104, 202, 302). The processes described in block 1002-1012 may be performed in response to determining that the user selected connection type is a future alert access connection type.

Following the performance of the operations of block 612 of the method 600 (FIG. 6), the processor may perform operations including storing, in an alert database, the device ID of the second wireless device as described in block 1002.

In block 1004, the processor may perform operations including disconnecting the first wireless device from the second wireless device.

In block 1006, the processor may perform operations including receiving, from a subsequent wireless device, a subsequent device ID.

In block 1008, the processor may perform operations including comparing the subsequent device ID against the device ID stored in the alert database.

In block 1010, the processor may perform operations including determining that the subsequent device ID matches the device ID such that the subsequent wireless device is the second wireless device.

In block 1012, the processor may perform operations including transmitting a notification to the second wireless device, wherein the notification includes a request for additional authentication information.

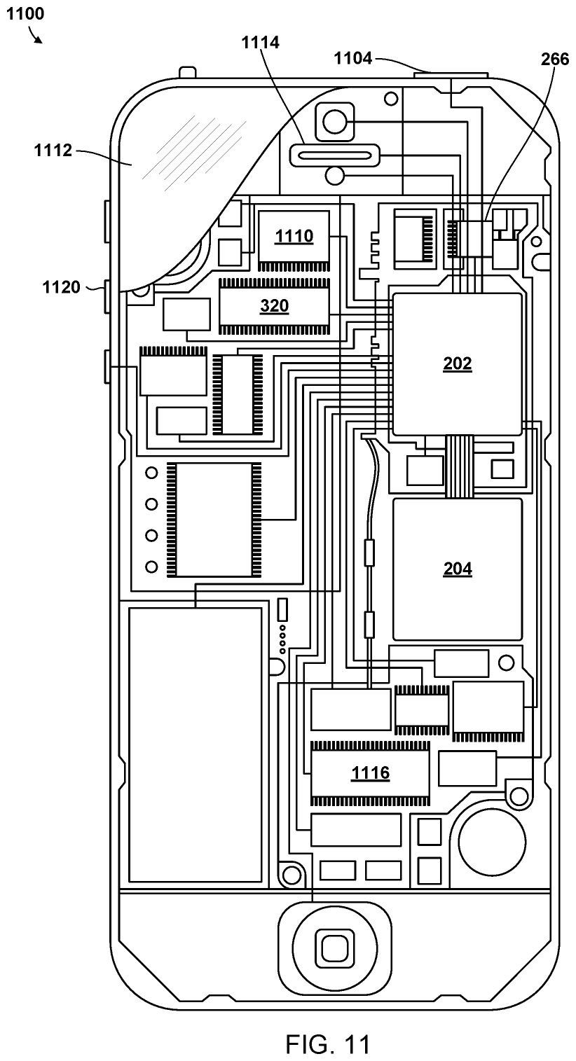

FIG. 11 is a component block diagram of an example wireless device in the form of a smartphone 1100 suitable for implementing some embodiments. With reference to FIGS. 1-11, a smartphone 1100 may include a first SOC 202 (such as a SOC-CPU) coupled to a second SOC 204 (such as a BLE capable SOC). The first and second SOCs 202, 204 may be coupled to internal memory 320, 1116, a display 1112, and to a speaker 1114. Additionally, the smartphone 1100 may include an antenna 1104 for sending and receiving electromagnetic radiation that may be connected to a wireless data link or cellular telephone transceiver 266 coupled to one or more processors in the first or second SOCs 202, 204. Smartphones 1100 typically also include menu selection buttons or rocker switches 1120 for receiving user inputs.

A typical smartphone 1100 also includes a sound encoding/decoding (CODEC) circuit 1110, which digitizes sound received from a microphone into data packets suitable for wireless transmission and decodes received sound data packets to generate analog signals that are provided to the speaker to generate sound. Also, one or more of the processors in the first and second SOCs 202, 204, wireless transceiver 266 and CODEC 1110 may include a digital signal processor (DSP) circuit (not shown separately).

The processors of the smart phone 1100 may be any programmable microprocessor, microcomputer or multiple processor chip or chips that may be configured by processor-executable instructions to perform a variety of functions, including the functions of the various embodiments described herein. In some wireless devices, multiple processors may be provided, such as one processor within an SOC 204 dedicated to wireless communication functions and one processor within an SOC 202 dedicated to running other applications. Typically, software applications may be stored in the memory 320, 1116 before they are accessed and loaded into the processor. The processors may include internal memory sufficient to store the application software instructions.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, or a computer. By way of illustration, both an application running on a wireless device and the wireless device may be referred to as a component. One or more components may reside within a process or thread of execution and a component may be localized on one processor or core or distributed between two or more processors or cores. In addition, these components may execute from various non-transitory computer readable media having various instructions or data structures stored thereon. Components may communicate by way of local or remote processes, function or procedure calls, electronic signals, data packets, memory read/writes, and other known network, computer, processor, or process related communication methodologies.

A number of different cellular and mobile communication services and standards are available or contemplated in the future, all of which may implement and benefit from the various embodiments. Such services and standards include, such as third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), 3GSM, general packet radio service (GPRS), code division multiple access (CDMA) systems (such as cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, or content messages. It should be understood that any references to terminology or technical details related to an individual telecommunication standard or technology are for illustrative purposes only, and are not intended to limit the scope of the claims to a particular communication system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods disclosed herein may be substituted for or combined with one or more operations of the methods disclosed herein.

The foregoing method descriptions and the process flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of various embodiments.

The hardware and data processing apparatus used to implement the various illustrative logics, logical blocks, modules, and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Embodiments of the subject matter described in this specification also may be implemented as one or more computer programs, i.e. one or more modules of computer program instructions, encoded on a computer storage media for execution by, or to control the operation of, data processing apparatus.

Computer program code or “program code” for execution on a programmable processor for carrying out operations of the various embodiments may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc in which disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the embodiments described in this disclosure may be readily apparent to those skilled in the art, and the generic principles defined herein may be applied to other embodiments without departing from the scope of the claims. Thus, the claims are not intended to be limited to the embodiments shown herein, but are to be accorded the widest scope consistent with this disclosure, the principles and the novel features disclosed herein.

1. A method performed by a processor of a first wireless device to establish secure communications with a second wireless device, comprising:
detecting that the second wireless device is within mid-to-short communication range of the first wireless device for establishing secure wireless communications:
receiving a user selected connection type selected by a user of the first wireless device for connecting the first wireless device to the second wireless device;
establishing a wireless connection to the second wireless device using a one-time password (OTP) exchange and selected features access permissions; and
in response to determining that the user selected connection type is a one-time temporary access connection type:
storing a device identification (ID) of the second wireless device for a duration of the wireless connection; and
deleting the stored device ID upon disconnection of the first wireless device from the second wireless device to prevent future automatic connections.

2. The method of claim 1, further comprising in response to determining that the user selected connection type is a limited feature access connection type:
displaying, in a user interface of the first wireless device, a list of selected features accessible in subsequent connections that are already configured by the user of the first wireless device in the limited features configuration settings module; and
storing, in a limited features database, the device ID of the second wireless device in association with the selected features.

3. The method of claim 2, further comprising:
disconnecting the first wireless device from the second wireless device;
overriding access permissions granted to the second wireless device in configuration settings of the first wireless device based on the limited features configuration settings module;
receiving a subsequent device ID from a subsequent wireless device;
comparing the subsequent device ID against the device ID stored in the limited features database;
determining whether the subsequent device ID matches the device ID such that the subsequent wireless device is the second wireless device; and
automatically connecting to the second wireless device based on the overridden access permissions in response to determining that the subsequent device ID matches the device ID.

4. The method of claim 3, further comprising:
displaying, in the user interface of the first wireless device, a permanent upgrade option and a temporary upgrade option for permanently or temporarily upgrading to the selected features stored in the limited features database associated with the device ID;
receiving a selection of an upgrade option to upgrade to the selected features permanently or temporarily;
determining whether the selected upgrade option is the permanent upgrade option or the temporary upgrade option;
in response to determining that the selected upgrade option is a temporary upgrade option:
upgrading access permissions to allow the second wireless device to access the selected features of the first wireless device;
disconnecting the first wireless device from the second wireless device; and
overriding access permissions granted to the second wireless device in the configuration settings of the first wireless device based on the limited features configuration settings module; and
in response to determining that the selected upgrade option is a permanent upgrade option:
storing the device ID in a user database of the first wireless device; and
deleting the device ID from the limited features database.

5. The method of claim 1, further comprising:
in response to determining that the user selected connection type is a future alert access connection type:
storing, in an alert database, the device ID of the second wireless device;
disconnecting the first wireless device from the second wireless device;
receiving a subsequent device ID from a subsequent wireless device;
comparing the subsequent device ID against the device ID stored in the alert database;
determining whether the subsequent device ID matches the device ID such that the subsequent wireless device is the second wireless device; and
transmitting a notification to the second wireless device that includes a request for additional authentication information in response to determining that the subsequent device ID matches the device ID.

6. The method of claim 1, wherein receiving the user selected connection type for connecting the first wireless device to the second wireless device comprises:
receiving, from a user interface of the first wireless device, a selection of the second wireless device from a list of available wireless devices to begin establishing a wireless connection with the second wireless device;
displaying, on the user interface, a user-selectable option to establish the wireless connection using a guest mode;
receiving, from the user interface, a selection to establish the wireless connection using the guest mode; and
displaying, on the user interface, user-selectable options for guest mode connection types.

7. The method of claim 1, wherein connecting the first wireless device to the second wireless device is performed according to Bluetooth Low Energy (BLE) communication standards.

8. The method of claim 1, wherein connecting the first wireless device to the second wireless device is performed according to Wi-Fi communication standards.

9. A first wireless device, comprising:
a processor configured with processor-executable instructions to:
detect that a second wireless device is within mid-to-short communication range of the first wireless device for establishing secure wireless communications;
receive a user selected connection type selected by a user of the first wireless device for connecting the first wireless device to a second wireless device;
establish a wireless connection to the second wireless device using a one-time password (OTP) exchange and selected features access permissions; and
in response to determining that the user selected connection type is a one-time temporary access connection type:
store a device ID of the second wireless device for a duration of the wireless connection; and
delete the stored device ID upon disconnection of the first wireless device from the second wireless device to prevent future automatic connections.

10. The first wireless device of claim 9, wherein the processor is further configured with processor-executable instructions to:
display, in a user interface of the first wireless device, a list of selected features accessible in subsequent connections which are already configured by the user of the first wireless device in the limited features configuration settings module in response to determining that the user selected connection type is a limited feature access connection type; and
store, in a limited features database, the device ID of the second wireless device in association with the selected features.

11. The first wireless device of claim 10, wherein the processor is further configured with processor-executable instructions to:
disconnect the first wireless device from the second wireless device;
override access permissions granted to the second wireless device in configuration settings of the first wireless device based on the limited features configuration settings module;
receive a subsequent device ID from a subsequent wireless device;
compare the subsequent device ID against the device ID stored in the limited features database;
determine whether the subsequent device ID matches the device ID such that the subsequent wireless device is the second wireless device; and
automatically connect to the second wireless device based on the overridden access permissions in response to determining that the subsequent device ID matches the device ID.

12. The first wireless device of claim 11, wherein the processor is further configured with processor-executable instructions to:
display, in the user interface of the first wireless device, a permanent upgrade option and a temporary upgrade option for permanently or temporarily upgrading to the selected features stored in the limited features database associated with the device ID;
receive a selection of an upgrade option to upgrade to the selected features permanently or temporarily;
determine whether the selected upgrade option is the permanent upgrade option or the temporary upgrade option;
in response to determining that the selected upgrade option is a temporary upgrade option:
upgrade access permissions to allow the second wireless device to access the selected features of the first wireless device;
disconnect the first wireless device from the second wireless device; and
override access permissions granted to the second wireless device in the configuration settings of the first wireless device based on the limited features configuration settings module; and
in response to determining that the selected upgrade option is a permanent upgrade option:
store the device ID in a user database of the first wireless device; and
delete the device ID from the limited features database.

13. The first wireless device of claim 9, wherein the processor is further configured with processor-executable instructions to:
in response to determining that the user selected connection type is a future alert access connection type:
store, in an alert database, the device ID of the second wireless device;
disconnect the first wireless device from the second wireless device;
receive a subsequent device ID from a subsequent wireless device;
compare the subsequent device ID against the device ID stored in the alert database;
determine whether the subsequent device ID matches the device ID such that the subsequent wireless device is the second wireless device; and
transmit a notification to the second wireless device that includes a request for additional authentication information in response to determining that the subsequent device ID matches the device ID.

14. The first wireless device of claim 9, wherein the processor is further configured with processor-executable instructions to receive the user selected connection type for connecting the first wireless device to the second wireless device by:
receiving, from a user interface of the first wireless device, a selection of the second wireless device from a list of available wireless devices to begin establishing a wireless connection with the second wireless device;
displaying, on the user interface, a user-selectable option to establish the wireless connection using a guest mode;
receiving, from the user interface, a selection to establish the wireless connection using the guest mode; and
displaying, on the user interface, user-selectable options for guest mode connection types.

15. The first wireless device of claim 9, wherein the processor is further configured with processor-executable instructions to establish the wireless connection to the second wireless device using a OTP exchange and selected features access permissions according to Bluetooth Low Energy (BLE) communication standards.

16. The first wireless device of claim 9, wherein the processor is further configured with processor-executable instructions to establish the wireless connection to the second wireless device using a OTP exchange and selected features access permissions according to Wi-Fi communication standards.

17. A non-transitory processor-readable medium having stored thereon processor-executable instructions configured to cause a processor of a first wireless device to perform operations comprising:
detecting that a second wireless device is within mid-to-short communication range of the first wireless device for establishing secure wireless communications;
receiving a user selected connection type selected by a user of the first wireless device for connecting the first wireless device to a second wireless device;
establishing a wireless connection to the second wireless device using a one-time password (OTP) exchange and selected features access permissions; and
in response to determining that the user selected connection type is a one-time temporary access connection type:
storing a device identification (ID) of the second wireless device for a duration of the wireless connection; and
deleting the stored device ID upon disconnection of the first wireless device from the second wireless device to prevent future automatic connections.

18. The non-transitory processor-readable medium of claim 17, wherein the stored processor-executable instructions are further configured to cause the processor to perform operations in response to determining that the user selected connection type is a limited feature access connection type comprising:
displaying, in a user interface of the first wireless device, a list of selected features accessible in subsequent connections which are already configured by the user of the first wireless device in the limited features configuration settings module; and
storing, in a limited features database, the device ID of the second wireless device in association with the selected features.

19. The non-transitory processor-readable medium of claim 18, wherein the stored processor-executable instructions are configured to cause the processor to perform operations further comprising:
disconnecting the first wireless device from the second wireless device;
overriding access permissions granted to the second wireless device in configuration settings of the first wireless device based on the limited features configuration settings module;
receiving a subsequent device ID from a subsequent wireless device;
comparing the subsequent device ID against the device ID stored in the limited features database;
determining whether the subsequent device ID matches the device ID such that the subsequent wireless device is the second wireless device; and
automatically connecting to the second wireless device based on the overridden access permissions in response to determining that the subsequent device ID matches the device ID.

20. The non-transitory processor-readable medium of claim 19, wherein the stored processor-executable instructions are configured to cause the processor to perform operations further comprising:
displaying, in the user interface of the first wireless device, a permanent upgrade option and a temporary upgrade option for permanently or temporarily upgrading to the selected features stored in the limited features database associated with the device ID;
receiving a selection of an upgrade option to upgrade to the selected features permanently or temporarily;
determining whether the selected upgrade option is the permanent upgrade option or the temporary upgrade option;
in response to determining that the selected upgrade option is a temporary upgrade option:
upgrading access permissions to allow the second wireless device to access the selected features of the first wireless device;
disconnecting the first wireless device from the second wireless device; and
overriding access permissions granted to the second wireless device in the configuration settings of the first wireless device based on the limited features configuration settings module; and
in response to determining that the selected upgrade option is a permanent upgrade option:
storing the device ID in a user database of the first wireless device; and
deleting the device ID from the limited features database.

21. The non-transitory processor-readable medium of claim 17, wherein the stored processor-executable instructions are configured to cause the processor to perform operations further comprising:
in response to determining that the user selected connection type is a future alert access connection type:
storing, in an alert database, the device ID of the second wireless device;
disconnecting the first wireless device from the second wireless device;
receiving a subsequent device ID from a subsequent wireless device;
comparing the subsequent device ID against the device ID stored in the alert database;
determining whether the subsequent device ID matches the device ID such that the subsequent wireless device is the second wireless device; and
transmitting a notification to the second wireless device that includes a request for additional authentication information in response to determining that the subsequent device ID matches the device ID.

22. The non-transitory processor-readable medium of claim 17, wherein the stored processor-executable instructions are configured to cause the processor to perform operations such that receiving the user selected connection type for connecting the first wireless device to the second wireless device comprises:
receiving, from a user interface of the first wireless device, a selection of the second wireless device from a list of available wireless devices to begin establishing a wireless connection with the second wireless device;
displaying, on the user interface, a user-selectable option to establish the wireless connection using a guest mode;
receiving, from the user interface, a selection to establish the wireless connection using the guest mode; and
displaying, on the user interface, user-selectable options for guest mode connection types.

23. The non-transitory processor-readable medium of claim 17, wherein the stored processor-executable instructions are configured to cause the processor to perform operations such that connecting the first wireless device to the second wireless device is performed according to Bluetooth Low Energy (BLE) communication standards.

24. The non-transitory processor-readable medium of claim 17, wherein the stored processor-executable instructions are configured to cause the processor to perform operations such that connecting the first wireless device to the second wireless device is performed according to Wi-Fi communication standards.

25. A first wireless device, comprising:
means for detecting that a second wireless device is within mid-to-short communication range of the first wireless device for establishing secure wireless communications;
means for receiving a user selected connection type selected by a user of the first wireless device for connecting the first wireless device to a second wireless device;
means for establishing a wireless connection to the second wireless device using a one-time password (OTP) exchange and selected features access permissions;
means for storing a device ID of the second wireless device for a duration of the wireless connection in response to determining that the user selected connection type is a one-time temporary access connection type; and
means for deleting the stored device ID upon disconnection of the first wireless device from the second wireless device to prevent future automatic connections.
